(19) United States
(12) Patent Application Publication
(10) Pub. No.: US 2026/0300402 A1
(43) Pub. Date: Oct. 1, 2026

(54) CONTENT RETRIEVAL METHOD BASED ON MACHINE LEARNING MODEL, STORAGE MEDIUM, AND ELECTRONIC DEVICE

(71) Applicant: Beijing Volcano Engine Technology Co., Ltd., Beijing (CN)

(72) Inventors: Qilong ZHANG, Beijing (CN); Feng GUO, Beijing (CN); Xiaodong SU, Beijing (CN); Yu ZHANG, Los Angeles, CA (US); Zhengqin LUO, Los Angeles, CA (US)

(21) Appl. No.: 19/420,265

(22) Filed: Dec. 15, 2025

(30) Foreign Application Priority Data
Mar. 28, 2025 (CN) 202510387285.7

(51) Int. Cl. G06F 16/903

(52) U.S. Cl. CPC G06F 16/90335

(57) ABSTRACT

The present disclosure provides a content retrieval method based on a machine learning model, a storage medium, and an electronic device. The content retrieval method includes: determining, in response to receiving a query request, a first content object associated with the query request, where the first content object includes a plurality of content segments and a plurality of groups of identifications respectively corresponding to the plurality of content segments; providing the query request and the first content object to the machine learning model, to obtain at least one second index, where the at least one second index respectively indicates at least one target content segment in the plurality of content segments; and extracting, based on the at least one second index and the plurality of groups of identifications, the at least one target content segment from the first content object, to answer the query request.

### CROSS-REFERENCE TO RELATED APPLICATION

The present application claims the priority to Chinese Patent Application No. 202510387285.7, filed on Mar. 28, 2025, the entire disclosure of which is incorporated herein by reference as portion of the present application.

### TECHNICAL FIELD

Example embodiments of the present disclosure relate to a content retrieval method based on a machine learning model, an apparatus, a device, a computer-readable storage medium, and a computer program product.

### BACKGROUND

Artificial intelligence technologies have been widely used in various information retrieval scenarios, for example, a machine learning model may be used to retrieve required information in content objects such as texts and tables. The machine learning model, due to its powerful natural language understanding and reasoning capabilities, may accurately understand the user's retrieval intention, thereby providing accurate retrieval results.

### SUMMARY

The present disclosure provides a content retrieval method based on a machine learning model. The method includes: determining, in response to receiving a query request, a first content object associated with the query request, where the first content object includes a plurality of content segments and a plurality of groups of identifications respectively corresponding to the plurality of content segments, and each group of identifications includes at least a first index of a corresponding content segment; providing the query request and the first content object to the machine learning model, to obtain at least one second index output by the machine learning model, where the at least one second index respectively indicates at least one target content segment in the plurality of content segments; and extracting, based on the at least one second index and the plurality of groups of identifications, the at least one target content segment from the first content object, to answer the query request.

The present disclosure further provides a content retrieval apparatus based on a machine learning model. The apparatus includes: a determining module configured to determine, in response to receiving a query request, a first content object associated with the query request, where the first content object includes a plurality of content segments and a plurality of groups of identifications respectively corresponding to the plurality of content segments, and each group of identifications includes at least a first index of a corresponding content segment; a providing module configured to provide the query request and the first content object to the machine learning model, to obtain at least one second index output by the machine learning model, where the at least one second index respectively indicates at least one target content segment in the plurality of content segments; and an extraction module configured to extract, based on the at least one second index and the plurality of groups of identifications, the at least one target content segment from the first content object, to answer the query request.

The present disclosure further provides an electronic device is provided. The device includes at least one processor; and at least one memory coupled to the at least one processor and storing instructions executable by the at least one processor, the instructions, when executed by the at least one processor, cause the device to perform the above-mentioned method.

The present disclosure further provides a computer-readable storage medium is provided. The computer-readable storage medium stores computer-executable instructions thereon, and the computer-executable instructions are executable by a processor to implement the above-mentioned method.

The present disclosure further provides a computer program product is provided, including computer-executable instructions which, when executed by a processor, implement the above-mentioned method.

It should be understood that the content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF DRAWINGS

The above and other features, advantages, and aspects of the embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which at least one embodiment according to the present disclosure may be implemented;

FIG. 2 shows a flowchart of a process of content retrieval based on a machine learning model according to at least one embodiment of the present disclosure;

FIG. 3 shows a schematic diagram of an example of a tree structure according to at least one embodiment of the present disclosure;

FIG. 4 shows a schematic structural block diagram of an example content retrieval apparatus based on a machine learning model according to at least one embodiment of the present disclosure; and

FIG. 5 shows a block diagram of an electronic device capable of implementing at least one embodiment of the present disclosure.

### DETAILED DESCRIPTION

The embodiments of the present disclosure will be described in more detail below with reference to the drawings. Although certain embodiments of the present disclosure are shown in the drawings, it should be understood that the present disclosure may be implemented in various forms, and should not be construed as limited to the embodiments set forth herein. On the contrary, these embodiments are provided for a more thorough and complete understanding of the present disclosure. It should be understood that the drawings and embodiments of the present disclosure are only used for exemplary purposes, rather than limiting the protection scope of the present disclosure.

In the description of the embodiments of the present disclosure, the term “include/comprise” and its similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below.

Herein, unless explicitly stated, the execution of a step “in response to A” does not mean that the step is executed immediately after “A”, but may include one or more intermediate steps.

It may be understood that the data involved in the present disclosure (including but not limited to the data itself, acquisition or use of the data) should comply with requirements of corresponding laws, regulations, and related provisions.

It may be understood that before using the technical solution disclosed in the embodiments of the present disclosure, the user shall be informed of the type, range of use, use scenarios, etc., of personal information involved in the present disclosure and the authorization of the user shall be obtained in an appropriate manner in accordance with relevant laws and regulations.

For example, in response to receiving an active request from a user, prompt information is sent to the user to clearly prompt the user that the requested operation will require access to and use of the user's personal information, so that the user may independently choose, based on the prompt information, whether to provide the personal information to software or hardware, such as an electronic device, an application, a server, or a storage medium, that performs the operations of the technical solution of the present disclosure.

As an optional but non-restrictive implementation, in response to receiving the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and obtaining user authorization is only illustrative, and does not constitute a limitation on the implementations of the present disclosure. Other manners that satisfy the relevant laws and regulations may also be applied to the implementations of the present disclosure.

As used herein, the term “model” may learn the correlation between corresponding input and output from training data, so that the corresponding output may be generated for a given input after the training is completed. The generation of the model may be based on machine learning techniques. Deep learning is a machine learning algorithm that uses multiple layers of processing units to process input and provide corresponding output. A neural network model is an example of a model based on deep learning. Herein, the “model” may also be referred to as a “machine learning model”, a “learning model”, a “machine learning network”, or a “learning network”, which are used interchangeably herein.

A “neural network” is a machine learning network based on deep learning. The neural network may process input and provide corresponding output, and usually includes an input layer and an output layer, as well as one or more hidden layers between the input layer and the output layer. The neural network used in deep learning applications usually includes many hidden layers, thereby increasing the depth of the network. The layers of the neural network are connected in sequence, so that the output of the previous layer is provided as the input of the next layer, where the input layer receives the input of the neural network, and the output of the output layer serves as the final output of the neural network. Each layer of the neural network includes one or more nodes (also referred to as processing nodes or neurons), and each node processes the input from the previous layer.

As mentioned above, with the rapid development of artificial intelligence technologies, a machine learning model may be used to retrieve required information from content objects such as documents and tables. For example, the content in the content object is usually divided into multiple content blocks. The machine learning model is used to perform feature matching based on a user query and the content blocks, so as to recall one or more content blocks matching the user query. The output latency and usage cost of the machine learning model are positively correlated with the number of output tokens. If there are a relatively large number of content blocks associated with the user query, the latency and usage cost will increase significantly. For example, content block division is usually performed according to the content length or data volume. In the retrieval process, the content related to the user query may not be fully recalled, or the recalled content blocks may contain irrelevant content. It may be seen that the retrieval strategy for information retrieval using the machine learning model still needs to be improved, and the retrieval cost still needs to be reduced.

In view of this, the embodiments of the present disclosure provide an improved solution for content retrieval based on a machine learning model. In this solution, in response to a query request being received, a first content object associated with the query request is determined. The first content object includes a plurality of content segments and a plurality of groups of identifications respectively corresponding to the plurality of content segments, and each group of identifications includes at least a first index of a corresponding content segment. The query request and the first content object are provided to the machine learning model, to obtain at least one second index output by the machine learning model. The at least one second index respectively indicates at least one target content segment in the plurality of content segments. Then, based on the at least one second index and the plurality of groups of identifications, the at least one target content segment is extracted from the first content object, to answer the query request.

In the embodiments of the present disclosure, the machine learning model is used to determine the target content segment matching the query request, but the machine learning model does not directly output the retrieved target content segment, but outputs the index of the target content segment. Then, the index is used to extract the target content segment from the content object to answer the query request. In this way, the understanding and reasoning capabilities of the machine learning model are fully utilized to ensure the accuracy of the retrieval results. Moreover, the number of tokens that need to be output by the machine learning model may be significantly reduced, which is beneficial to reducing the retrieval latency and retrieval cost.

Various embodiments of the present disclosure are described in detail below with further reference to the drawings.

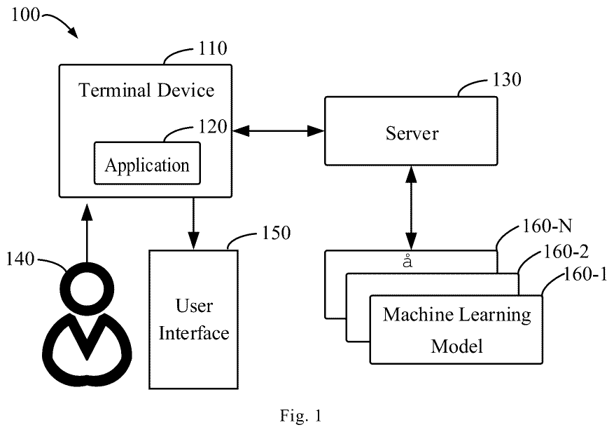

FIG. 1 shows a schematic diagram of an example environment 100 in which at least one embodiment of the present disclosure may be implemented. In this example environment 100, an application 120 is installed on a terminal device 110. A user 140 may interact with the application 120 via the terminal device 110 and/or an attachment device of the terminal device 110.

In some embodiments of the present disclosure, the application 120 may be any appropriate application with an information query function. For example, the application 120 may provide a digital assistant for information query. The digital assistant supports the user 140 to use a query request in text, voice, or other modalities. In some embodiments, if the application 120 is active, the terminal device 110 may present a user interface 150 of the application 120. The user interface 150 may include various types of pages provided by the application 120, such as a conversation page between the user and the digital assistant, a presentation interface of retrieved content, and so on. In some embodiments, the terminal device 110 may play voice in the user interface 150, and the voice may be, for example, the voice corresponding to the retrieved text content.

In some embodiments, the application 120, or the digital assistant therein, may use a machine learning model 160 (which may include one or more machine learning models, for example, a machine learning model 160-1, a machine learning model 160-2, . . . , a machine learning model 160-N, etc., where N is a positive integer. For the convenience of description, the one or more machine learning models are collectively referred to as a machine learning model 160 herein) to support the interaction with the user 140. For example, the application 120, or the digital assistant therein, may use the one or more machine learning models 160 to provide an information query service to the user 140. In some embodiments, the terminal device 110 may communicate with a server 130 to implement the provision of the service of the application 120. As shown in FIG. 1, the server 130 may invoke the machine learning model 160 to support the application 120 to provide the information query service to the user 140 based on the output of the machine learning model 160.

In some embodiments, the machine learning model 160 may be a different type of model. In some embodiments, the one or more machine learning models 160 may be built based on a language model (LM). The machine learning model used is a content generation model, which may generate a corresponding output based on a model input. In some embodiments, the machine learning model based on the language model may accept a model input in a text modality (for example, a natural language and/or a machine language) and/or a model input in a non-text modality (for example, an image, a voice, a video, etc.), and generate a desired output based on the model input and a prompt. The prompt here is used to guide the machine learning model to generate content that may solve a user query indicated by the model input. In an application scenario for supporting a user conversation, the input of the user 140 may be provided to the machine learning model 160 as at least a part of the model input (other parts may include the prompt). The user input is regarded as a question or a query request. Based on the model output, a corresponding answer may be provided to the user 140.

In some embodiments, the one or more machine learning models 160 may be voice-related models, including a speech recognition (ASR) model and a text-to-speech (TTS) model. The input of the ASR model is voice, and the output is text. The input of the TTS model is text, and the output is corresponding voice.

In some embodiments, the terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including the accessories and peripherals of these devices, or any combination thereof. In some embodiments, the terminal device 110 may also support any type of user-specific interface (such as “wearable” circuitry, etc.).

In some embodiments, the server 130 may include, but is not limited to, a mainframe, an edge computing node, a computing device in a cloud environment, and the like. The server 130 may be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server may include, for example, a computing system/server, such as a mainframe, an edge computing node, a computing device in a cloud environment, and so on.

It should be understood that the structure and function of each element in the environment 100 are described for exemplary purposes only, without suggesting any limitations on the scope of the present disclosure.

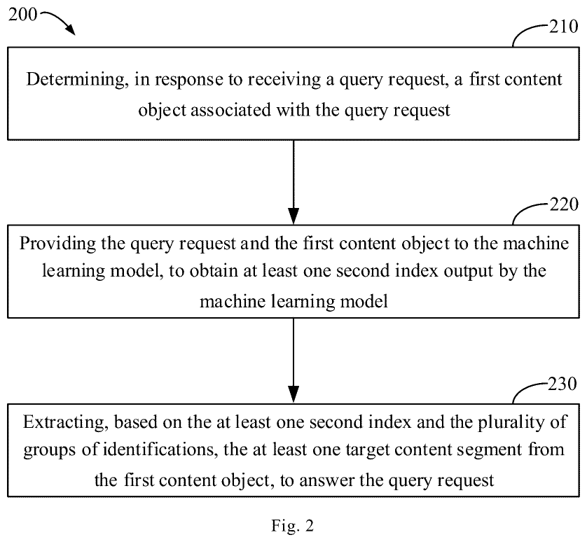

Some example embodiments of the present disclosure will be described below with continued reference to the drawings. FIG. 2 shows a flowchart of a process 200 of content retrieval based on a machine learning model according to at least one embodiment of the present disclosure. Hereinafter, for the convenience of discussion, the execution of the process 200 is described from the perspective of the server 130, but this is only exemplary. The process 200 may also be executed by the terminal device 110, or may be executed by the terminal device 110 and the server 130 in cooperation.

At block 210, in response to a query request being received, the server 130 determines a first content object associated with the query request. The first content object includes a plurality of content segments and a plurality of groups of identifications, and the plurality of groups of identifications respectively indicate the plurality of content segments. In some embodiments, the first content object may include a text, a table, an image, an audio, a video, or a combination of one or more of the above, and so on. For example, the first content object may be a document, and the document may include a text, a table, an image, etc.

Each group of identifications includes at least a first index indicating a corresponding content segment. In the case where the first content object has different modalities, the content segments and the first index may also be different. As an example, the first content object may include a text, and the plurality of content segments may include a plurality of text segments. The first index may include various data content (for example, words, symbols, tags, etc.) that indicate the corresponding text segment. As another example, the first content object may include an audio, the content segments may include audio segments, and the first index may include, for example, a time stamp. Certainly, the above types of the first content object and the first index are both exemplary, and any other appropriate first content object and any other appropriate first index may be selected, which is not limited in the embodiments of the present disclosure.

In some embodiments, the server 130 may query an associated content object from a predetermined data source (for example, a database) in response to receiving the query request from the terminal device 110. For example, the server 130 may query, from the database associated with the application 120, the content object associated with the query request of the user 140. Certainly, the server 130 may also acquire the content object from other data sources, for example, the server 130 may also acquire a content object provided by the user 140.

In some embodiments, the server 130 may acquire a content object in a predetermined format from a predetermined data source based on the query request, and the content object in the predetermined format may include at least part of identifications in the plurality of groups of identifications, for example, the content object in the predetermined format may include the first index in each group of identifications. In some embodiments, the first content object may include a document in the predetermined format. The document in the predetermined format may be, for example, a document in a markup language, such as a markdown document. As an example, the database associated with the application 120 may store a Markdown document, and the Markdown document may include at least part of identifications that indicate text segments.

In some embodiments, the content object acquired by the server 130 may not include the identifications of the content segments, and the server 130 may add the identifications to the acquired content object to obtain the first content object. Specifically, the server 130 may determine an original content object associated with the query request in response to the query request. The server 130 may identify a plurality of content segments from the original content object (for example, the plurality of content segments may be identified based on the correlation between the content or the content structure). Then, the server 130 may add a plurality of groups of identifications to the original content object based on the identification result, to obtain the first content object. In this way, even if the original content object is not provided with identifications, the required content may be retrieved from the original content object by adding the identifications to the original content object, which is beneficial to improving the flexibility and expanding the application scenarios. The original content object here may have the same or different modality as the first content object, for example, the original content object and the first content object may both include a text, for another example, the original content object may include a table or an audio, and the server 130 may convert the table or the audio into a text.

The specific content contained in the identifications and the process of adding the identifications are exemplarily described below with reference to some specific examples, but it should be understood that this is only exemplary. In an actual application scenario, the identifications are not limited to including the content as shown below, and are also not limited to being added to the content object in the manner as shown below.

In some embodiments, the plurality of content segments may be configured to include multi-level content segments, and the first index may include a level identification indicating a level of a corresponding content segment. The server 130 may determine the level of a first content segment in the plurality of content segments. Then, the server 130 may add, in the original content object, a level identification corresponding to the level of the first content segment as at least a part of the first index of the first content segment. The first content segment may be any content segment in the original content object.

As an example, the original content object and the first content object may be documents. The original content object may include an original document as shown in the following table.

TABLE 1
Title 1
Title 1.1
XXXXXXXXXXXXXX, XXXXXXXXXXX.
XXXXXXXXXXXXXXXXXX. XXXXXXX, XXXX, XXXXXXXXXX.
Title 1.2
Title 1.2.1
XXXXXXXXXXXX
Title 1.2.1.1
XXXXXXXXXXXX
Title 1.2.1.2
XXXXXXXXXXXX
Title X
XXXXXXXXXXXX
Title 1.3
XXXXXXXXXXXX

The server 130 may identify a plurality of text segments in the original document in Table 1. The server 130 may determine the levels of the plurality of text segments based on a predetermined rule (for example, a rule based on a document structure or a rule based on the correlation between content, etc.). For example, the server 130 may determine the text content to which “Title 1” belongs as a first-level text segment, determine the text content to which “Title 1.1”, “Title 1.2”, and “Title 1.3” belong as second-level text segments, determine the text content to which “Title 1.2.1” belongs as a third-level text segment, and so on. Then, the server 130 may add level identifications corresponding to the levels of the respective text segments to the original document shown in Table 1. For example, characters such as “#”, “##”, “###” are respectively added to the first-level text segment, the second-level text segment, and the third-level text segment to indicate the boundaries of the corresponding text segments. In this way, content segments may be efficiently and flexibly divided according to the correlation between the content, and the content matching the query request may be efficiently and flexibly output.

The document added with the level identifications may be as shown in the following table.

TABLE 2

| | |
|---|---|
| 1 | # Title 1 |
| 2 | ## Title 1.1 |
| 3 | XXXXXXXXX, XXXXXXXXX. |
| 4 | XXXXXXXXXXXXXXXXXX. |
| 5 | XXXXX, XXXX, XXXXXXXXX. |
| 6 | ## Title 1.2 |
| 7 | ### Title 1.2.1 |
| 8 | XXXXXXXXXXXX |
| 9 | 1. Title 1.2.1.1 |
| 10 | XXXXXXXXXXXX |
| 11 | 2. Title 1.2.1.2 |
| 12 | XXXXXXXXXXXX |
| 13 | - Title X |
| 14 | XXXXXXXXXXXX |
| 15 | ## Title 1.3 |
| 16 | XXXXXXXXXXXX |

In some embodiments, the content segments may not only have corresponding levels, but also have corresponding orders in a group of content segments with the same level. The server 130 may determine a level of a second content segment in the plurality of content segments and an order of the second content segment in a group of content segments with the same level. Then, the server 130 may add, to the original content object, an order identification corresponding to the order of the second content segment as at least a part of the first index of the second content segment. In this way, the order of respective content segments may be accurately identified by using the first index, which is beneficial to accurately outputting the retrieval result subsequently.

As an example, still referring to the documents shown in Table 1 and Table 2, the server 130 may determine the content corresponding to “Title 1.2.1.1” and “Title 1.2.1.2” in Table 1 as ordered list segments, and the orders of the ordered list segments corresponding to “Title 1.2.1.1” and “Title 1.2.1.2” are respectively “1” and “2”. The server 130 may also determine the content corresponding to “Title X” in Table 1 as an unordered list segment. Then, the server 130 may add order identifications “1.” and “2.” to the document shown in Table 1 to respectively indicate the orders of the ordered list segments corresponding to “1. Title 1.2.1.1” and “2. Title 1.2.1.2”, and the server 130 may also add an order identification “-” indicating that the content corresponding to “-Title X” is an unordered list segment to the document shown in Table 1.

It is also to be noted that the level relationship between the text segments may be predefined, for example, it may be predetermined that the ordered text segments and the unordered text segments have the same level, and the level of the ordered text segments and the unordered text segments is lower than the level of the first-level text segment, the second-level text segment, and the third-level text segment. In this case, the order identifications “1.” and “2.” may not only indicate that the corresponding list segments belong to the ordered list segments and the orders of the corresponding list segments, but also indicate the level of the corresponding list segments to some extent. Similarly, “-” may not only indicate that the corresponding list segment belongs to an unordered list segment and that the corresponding list segment is not ordered, but also indicate the level of the corresponding list segment to some extent. It may be seen that in some cases, the order identification may also indicate the level of the corresponding content segment, and may also play the role of the level identification to some extent.

In some embodiments, each group of identifications includes a start identification indicating a start position of a corresponding content segment. The server 130 may determine a start position of a third content segment in the plurality of content segments. Then, in the original content object, a start identification is added to the start position of the third content segment as at least a part of the first index of the third content segment. As an example, the server 130 may determine the start positions of the text segments such as “Title 1”, “Title 1.1”, and “Title 1.2” in the document shown in Table 1. Then, the server 130 may add, for example, “#”, “##”, “###” to the start positions of the text segments corresponding to “Title 1”, “Title 1.1”, and “Title 1.2” in the document shown in Table 1 to indicate the start positions of these text segments. Certainly, the start identification is not limited to the above identification, and the server 130 may also add, for example, “begin” or other characters to the start position of the text segment to indicate the start position of the corresponding text segment.

In some embodiments, each group of identifications may further include a termination identification indicating an end position of the corresponding content segment. The server 130 may identify the end positions of the plurality of content segments from the original content object. Then, the server 130 may respectively add termination identifications to the end positions corresponding to the plurality of content segments in the original content object. For example, the server 130 may add characters such as “end” to the end position of the content segment in the original content object to represent the end position of the content segment. By adding the termination identification, the end position of each content segment may be accurately identified, which in turn facilitates the accurate extraction of the content segment.

In some examples, if the plurality of content segments include multi-level content segments, the server 130 may determine that two adjacent content segments in the original content object are both at a first level, and add a first termination identification corresponding to the first level to the identified end position of the previous content segment in the two adjacent content segments. The first level may be any level, and accordingly, that the two adjacent content segments being both at the first level may be understood as that the two adjacent content segments have the same level. That is, if the two adjacent content segments have the same level, the server 130 adds the termination identification corresponding to the level of the previous content segment to the end position of the previous content segment.

As an example, taking the document shown in Table 2 as an example, the text segment corresponding to “##Title 1.1” and the text segment corresponding to “##Title 1.2” are both second-level text segments, and accordingly, the server 130 may add the characters “┌##end┘” as a termination identification to the end position of the text segment corresponding to “##Title 1.1”. Similarly, the text segment corresponding to “1. Title 1.2.1.1” and the text segment corresponding to “2. Title 1.2.1.2” are both ordered list segments, and the server 130 may add the characters “┌1. end┘” as a termination identification to the end position of the ordered list segment corresponding to “1. Title 1.2.1.1”. The details are shown in Table 3.

TABLE 3

| | |
|---|---|
| 1 | # Title 1 |
| 2 | ## Title 1.1 |
| 3 | XXXXXXXXX, XXXXXXXXX. |
| 4 | XXXXXXXXXXXXXXXXXX. |
| 5 | XXXXX, XXXX, XXXXXXXXX. |
| 6 | ┌## end┘ |
| 7 | ## Title 1.2 |
| 8 | ### Title 1.2.1 |
| 9 | XXXXXXXXXXXX |
| 10 | 1. Title 1.2.1.1 |
| 11 | XXXXXXXXXXXX |
| 12 | ┌1. end┘ |
| 13 | 2. Title 1.2.1.2 |
| 14 | XXXXXXXXXXXX |
| 15 | ┌2. end┘ |
| 16 | - Title X |
| 17 | XXXXXXXXXXXX |
| 18 | ┌- end┘ ┌### end┘ ┌## end┘ |
| 19 | ## Title 1.3 |
| 20 | XXXXXXXXXXXX. |
| 21 | ┌## end┘ ┌# end┘ |

In some examples, if it is determined that a previous content segment in two adjacent content segments in the original content object is at a second level and a subsequent content segment is at a third level higher than the second level, the server 130 may add a plurality of termination identifications to the identified end position of the previous content segment, where the plurality of termination identifications include at least a second termination identification corresponding to the second level and a third termination identification corresponding to the third level. As an example, still referring to Table 3, because the text segment corresponding to “-Title X” is an unordered list segment, and the text segment corresponding to “##Title 1.3” is a second-level text segment, the end position of the text segment corresponding to “-Title X” is also the end position of the text segment corresponding to “###Title 1.2.1” and the end position of the text segment corresponding to “##Title 1.2”. The server 130 may respectively add three termination identifications “┌-end┘”, “┌###end┘”, “┌##end┘” to that position.

In some embodiments, the server 130 may convert the original content object into a structured content object that conforms to a predetermined format. The structured content object in the predetermined format may include at least part of identifications in the plurality of groups of identifications. If the structured content object in the predetermined format contains all the identifications in the plurality of groups of identifications, the server 130 may use the structured content object in the predetermined format as the first content object. If the structured content object in the predetermined format includes part of identifications in the plurality of groups of identifications, the server 130 may also add the remaining part of identifications in the plurality of groups of identifications to the structured content object to form the first content object. For example, the structured object in the predetermined format may include the first index of each group of identifications in the plurality of groups of identifications, and the server 130 may also add a plurality of termination identifications corresponding to the plurality of content segments respectively to the structured object to obtain the first content object.

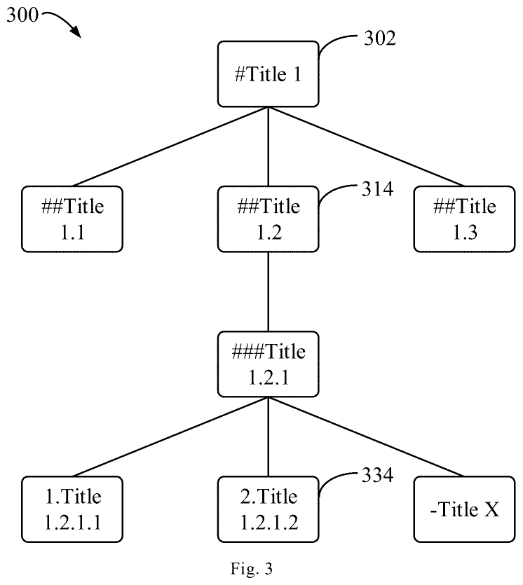

As an example, FIG. 3 shows a schematic diagram of an example 300 of a tree structure according to at least one embodiment of the present disclosure. If the server 130 acquires the original document shown in Table 1 according to the query request, the server 130 may identify the levels of a plurality of text segments in the original document to acquire the tree structure as shown in FIG. 3. Each node in the tree structure may indicate the level of a corresponding text segment, and the tree structure may also indicate the hierarchical relationship between the plurality of text segments. For example, the node 302 may indicate that the text segment corresponding to “Title 1” is a first-level text segment, the node 314 indicates that the text segment corresponding to “Title 1.2” is a second-level text segment, the node 334 indicates that the content corresponding to “Title 1.2.1.2” is an ordered list segment, and so on.

The server 130 may add a first index (which may also be referred to as an index name) to each node in the tree structure to obtain the structured document shown in Table 2. The first index may include, for example, at least one of a level identification, an order identification, and a title of the text segment (or part of content at the beginning of the text segment), and the first index may also include the title of the corresponding content segment. For example, the first index corresponding to the node 302 includes the level identification “#” and the title “Title 1” of the corresponding text segment. The first index corresponding to the node 334 includes the order identification “2.” and the title “Title 1.2.1.2”. It may be seen that the server 130 may achieve the purpose of adding at least part of identifications to the original document by converting the original document shown in Table 1 into a structured document such as the Markdown document shown in Table 2.

Further, the server 130 may also add a termination identification of each text segment, such as “┌-end┘”, “┌###end┘”, “┌##end┘”, etc., to the structured document shown in Table 2 to obtain the target, document shown in Table 3. The manner of adding the termination identification will not be repeated here, and reference may be made to the explanation of the preceding content.

As another example, if the original document is a structured document in a predetermined format such as a Markdown document, the original document actually already contains part of identifications in the plurality of groups of identifications. In this case, the server 130 may add the remaining part of identifications in the plurality of groups of identifications to the original document to form the first content object. For example, if the database associated with the application 120 stores the Markdown document shown in Table 2, the server 130 only needs to add the termination identifications as shown above to the Markdown document to obtain the first content object shown in Table 3.

In some embodiments, the server 130 may generate, based on the original content object, prompt information for the machine learning model 160-1. The server 130 may provide the prompt information to the machine learning model 160-1 to acquire the model output generated by the machine learning model 160-1. Then, the server 130 may determine the first content object based on the model output. That is, the server 130 may also use the machine learning model 160-1 to add identifications indicating content segments to the original content object, so as to improve the efficiency and accuracy of adding the identifications. It is to be noted that the above identifications and the manner of adding the identifications are only exemplary, and any appropriate identification may be selected according to the actual needs, and the identifications may also be added to the original content object in any appropriate manner. This is not limited in the embodiments of the present disclosure.

Returning to the process 200, at block 220, the server 130 may provide the query request and the first content object to the machine learning model 160-2 to obtain at least one second index output by the machine learning model 160-2. The second index indicates at least one target content segment in the plurality of content segments respectively. In some embodiments, the server 130 may generate, based on the query request, the first content object, and the description of the plurality of groups of identifications, prompt information for the machine learning model. The server 130 may provide the prompt information to the machine learning model 160-2 to obtain a model output generated by the machine learning model 160-2. Then, the server 130 may determine at least one second index based on the model output. The at least one second index may respectively indicate at least one target content segment matching the query request.

The description of the plurality of groups of identifications may be understood as an explanation of the identifications added to the content segments, so as to facilitate the machine learning model 160-2 to understand the division manner of the plurality of content segments in the first content object and the relationship (for example, a hierarchical relationship, a sequential relationship, etc.) between the plurality of content segments. As an example, for the target document shown in Table 3, the description of the plurality of groups of identifications may include, for example, that “text segments may be distinguished by the level identification ‘#’ of the first-level text segment, the level identification ‘##’ of the second-level text segment, the level identification ‘###’ of the third-level text segment, the order identification ‘-’ of the unordered list segment, the order identifications ‘1.’, ‘2.’ of the ordered list segments, and the corresponding termination identifications ‘#end’, ‘##end’, ‘###end’, ‘1. end’, ‘2. end’, ‘-end’, etc.”. It should be understood that the above description of the plurality of groups of identifications is only exemplary. In an actual application scenario, the plurality of groups of identifications may be described in any appropriate sentence, and the manner of describing the identifications is not limited in the embodiments of the present disclosure.

In some embodiments, the second index may include all or part of the content of the first index. As an example, the machine learning model 160-2 may be configured to output the same content as the first index of the target content segment as the second index. In some examples, the second index may include at least one of a level identification, an order identification, and a start identification of the corresponding target content segment, and the second index may also include the title of the corresponding target content segment. As an example, as shown in FIG. 3, the machine learning model 160-2 may be configured to output index names of respective nodes in the tree structure, such as “##Title 1.2”, “1. Title 1.2.1.1”, “-Title X”, and so on.

In some embodiments, if the plurality of content segments in the first content object include multi-level content segments, and the at least one target content segment includes a parent-level content segment and a child-level content segment belonging to the parent-level content segment, the machine learning model 160-2 may be configured to output the second index corresponding to the parent-level content segment, but not output the second index corresponding to the child-level content segment. In this way, content duplication may be avoided.

As shown in FIG. 2, at block 230, the server 130 extracts, based on the at least one second index and the plurality of groups of identifications, the at least one target content segment from the first content object, to answer the query request. In some embodiments, the server 130 may determine at least one group of identifications matching the at least one second index in the plurality of groups of identifications. Then, the server 130 may extract, based on the at least one group of identifications, the at least one target content segment from the first content object. As an example, the server 130 may use a regular expression to determine, based on the at least one second index, at least one group of identifications matching the at least one second index. Certainly, the identification matching the second index may also be determined in any other appropriate manner, which is not limited in the embodiments of the present disclosure.

In some embodiments, the server 130 may determine, based on the at least one second index, at least one first index matching the at least one second index and at least one termination identification corresponding to the at least one first index in the plurality of groups of identifications of the first content object. Then, the at least one target content segment is extracted from the first content based on the at least one first index and the at least one termination identification. As an example, referring to Table 3, if the machine learning model 160-2 outputs the second index “##Title 1.1”, the server 130 may determine the first index “##Title 1.1” in the document shown in Table 3 and the termination identification “##end” corresponding to the first index. Then, the server 130 may extract a corresponding second-level text segment from the document based on the first index “##Title 1.1” and the termination identification “##end”.

In some examples, the server 130 may feed back the at least one target content segment to the terminal device 110, and the terminal device 110 may present the at least one target content segment through the user interface 150 of the application 120 to answer the query request of the user 140. In some other examples, the server 130 may generate speech corresponding to the at least one target content segment, and the server 130 may provide the speech to the terminal device 110. The terminal device 110 may use the application 120 to play the speech to answer the query request of the user 140. Certainly, the server 130 may also provide the retrieval result to the user 140 in other manners.

In this way, in the embodiments of the present disclosure, the machine learning model is used to determine the target content segment matching the query request, but the machine learning model does not directly output the retrieved target content segment, but outputs the index of the target content segment. Then, the index is used to extract the target content segment from the content object to answer the query request. In this way, the understanding and reasoning capabilities of the machine learning model are fully utilized to ensure the accuracy of the retrieval results. Moreover, the number of tokens that need to be output by the machine learning model may be significantly reduced, which is beneficial to reducing the retrieval latency and retrieval cost.

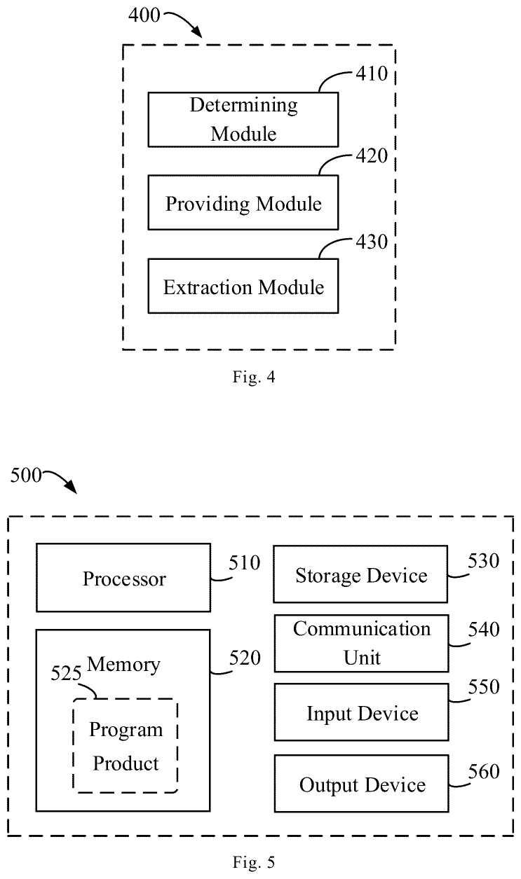

The embodiments of the present disclosure further provide corresponding apparatuses for implementing the above methods or processes. FIG. 4 shows a schematic structural block diagram of an example apparatus 400 for content retrieval based on a machine learning model according to at least one embodiment of the present disclosure. The apparatus 400 may be implemented as or included in the server 130. Each module/component in the apparatus 400 may be implemented by hardware, software, firmware, or any combination thereof.

As shown in FIG. 4, the apparatus 400 includes: a determining module 410 configured to determine, in response to receiving a query request, a first content object associated with the query request, where the first content object includes a plurality of content segments and a plurality of groups of identifications respectively corresponding to the plurality of content segments, and each group of identifications includes at least a first index of a corresponding content segment; a providing module 420 configured to provide the query request and the first content object to the machine learning model, to obtain at least one second index output by the machine learning model, where the at least one second index respectively indicates at least one target content segment in the plurality of content segments; and an extraction module 430 configured to extract, based on the at least one second index and the plurality of groups of identifications, the at least one target content segment from the first content object, to answer the query request.

In some embodiments, the determining module 410 is further configured to: identify the plurality of content segments from an original content object associated with the query request; and add the plurality of groups of identifications to the original content object based on a result of the identifying, to obtain the first content object.

In some embodiments, the plurality of content segments include multi-level content segments, and the determining module 410 is further configured to: determine a level of a first content segment in the plurality of content segments; and add, in the original content object, a level identification corresponding to the level of the first content segment as at least a part of the first index of the first content segment.

In some embodiments, the determining module 410 is further configured to: determine an order of a second content segment in the plurality of content segments in a group of content segments at a same level; and add, in the original content object, an order identification corresponding to the order of the second content segment as at least a part of the first index of the second content segment.

In some embodiments, the determining module 410 is further configured to: determine a start position of a third content segment in the plurality of content segments; and add, in the original content object, a corresponding start identification to the start position of the third content segment as at least a part of the first index of the third content segment.

In some embodiments, each group of identifications further includes a termination identification, and the determining module 410 is further configured to add, in the original content object, the termination identification to respective identified end positions of the plurality of content segments respectively.

In some embodiments, the plurality of content segments include multi-level content segments, and the determining module 410 is further configured to perform at least one of the following: in response to determining that two adjacent content segments in the original content object are both at a first level, adding a first termination identification corresponding to the first level to an identified end position of a previous content segment in the two adjacent content segments; or in response to determining that a previous content segment in two adjacent content segments in the original content object is at a second level and a subsequent content segment is at a third level higher than the second level, adding a plurality of termination identifications to an identified end position of the previous content segment, where the plurality of termination identifications include at least a second termination identification corresponding to the second level and a third termination identification corresponding to the third level.

In some embodiments, the providing module 420 is further configured to: generate, based on the query request, the first content object, and a description of the plurality of groups of identifications, prompt information for the machine learning model; and provide the prompt information to the machine learning model, to obtain, from the machine learning model, a model output indicating the at least one second index.

In some embodiments, the extraction module 430 is further configured to: determine at least one group of identifications matching the at least one second index in the plurality of groups of identifications; and extract, based on the at least one group of identifications, the at least one target content segment from the first content object.

In some embodiments, each group of identifications includes the first index of the corresponding content segment and a termination identification corresponding to the first index, the termination identification indicates an end position of the corresponding content segment, and the extraction module 430 is further configured to extract, based on at least one first index matching the at least one second index and at least one termination identification corresponding to the at least one first index, the at least one target content segment from the first content object.

The units and/or modules included in the apparatus 400 may be implemented in various ways, including software, hardware, firmware, or any combination thereof. In some embodiments, one or more units and/or modules may be implemented using software and/or firmware, such as machine-executable instructions stored on a storage medium. In addition to machine-executable instructions or as an alternative, some or all units and/or modules in the apparatus 400 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and so on.

FIG. 5 shows a block diagram of an electronic device 500 in which one or more embodiments of the present disclosure may be implemented. It should be understood that the electronic device 500 shown in FIG. 5 is only exemplary, and should not constitute any limitation on the functionality and scope of the embodiments described herein. The electronic device 500 shown in FIG. 5 may include or be implemented as the server 130 in FIG. 1, or the apparatus 400 in FIG. 4.

As shown in FIG. 5, the electronic device 500 is in the form of a general electronic device. The components of the electronic device 500 may include, but are not limited to, one or more processors 510, a memory 520, a storage device 530, one or more communication units 540, one or more input devices 550, and one or more output devices 560. The processor 510 may be an actual or virtual processor and may execute various processes based on the executable instructions stored in the memory 520. In a multi-processor system, multiple processors execute computer-executable instructions in parallel to improve the parallel processing capability of the electronic device 500.

The electronic device 500 typically includes multiple computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 530 may be a removable or non-removable medium, and may include a machine-readable medium such as a flash drive, a disk, or any other medium, which may be used to store information and/or data and may be accessed within the electronic device 500.

The electronic device 500 may further include additional removable/non-removable, volatile/non-volatile memory medium. Although not shown in FIG. 5, a disk drive for reading from or writing to a removable, non-volatile disk (such as a “floppy disk”), and an optical disk drive for reading from or writing to a removable, non-volatile optical disk may be provided. In these cases, each drive may be connected to a bus (not shown) by one or more data medium interfaces. The memory 520 may include a computer program product 525, which has one or more executable instruction modules configured to perform various methods or acts of various embodiments of the present disclosure.

The communication unit 540 implements communication with other electronic devices through the communication medium. In addition, the functions of the components of the electronic device 500 may be implemented by a single computing cluster or multiple computing machines, which may communicate through communication connections. Therefore, the electronic device 500 may use a logical connection with one or more other servers, a network personal computer (PC) or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may further communicate with one or more external devices (not shown) through the communication unit 540 as needed, the external devices such as a storage device, a display device, etc., communicate with one or more devices that enable the user to interact with the electronic device 500, or communicate with any devices (for example, a network card, a modem, etc.) that enable the electronic device 500 to communicate with one or more other electronic devices. Such communication may be performed via input/output (I/O) interfaces (not shown).

According to an exemplary implementation of the present disclosure, a computer-readable storage medium is provided, having computer-executable instructions stored thereon, where the computer-executable instructions are executed by a processor to implement the method described above. According to an exemplary implementation of the present disclosure, there is further provided a computer-executable instruction product, the computer-executable instruction product is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices, and computer-executable instruction products implemented according to the present disclosure. It should be understood that each block of the flowcharts and/or block diagrams, and combinations of blocks in the flowcharts and/or block diagrams, may be implemented by computer-readable executable instructions.

These computer-executable instructions may be provided to a processor of a general-purpose computer, a special-purpose computer, or other programmable data processing apparatus to produce a machine, such that when the instructions are executed by the processor of the computer or other programmable data processing apparatus, an apparatus for implementing the functions/acts specified in one or more blocks of the flowcharts and/or block diagrams is produced. These computer-executable instructions may also be stored in a computer-readable storage medium, these instructions cause the computer, the programmable data processing apparatus, and/or other devices to work in a specific manner, and thus, the computer-readable medium storing the instructions includes a manufactured product, which includes instructions for implementing various aspects of the functions/acts specified in one or more blocks of the flowcharts and/or block diagrams.

The computer-executable instructions may be loaded onto a computer, other programmable data processing apparatus, or other devices, so that a series of operation steps are performed on the computer, other programmable data processing apparatus or other devices to generate a computer-implemented process, so that the instructions executed on the computer, other programmable data processing apparatus, or other devices implement the functions/acts specified in one or more blocks of the flowcharts and/or block diagrams.

The flowcharts and block diagrams in the drawings show the possibly implemented architectures, functions, and operations of the system, method and computer-executable instruction product according to multiple implementations of the present disclosure. In this regard, each block in the flowchart or block diagram may represent a module, an executable instruction or a part of an instruction, and the module, the executable instruction or the part of the instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts may be implemented by a special-purpose hardware-based system that perform specified functions or acts, or may be implemented by a combination of special-purpose hardware and computer instructions.

The implementations of the present disclosure have been described above, and the above description is exemplary, non-exhaustive, and not limited to the disclosed implementations. Without departing from the scope and spirit of the described implementations, many modifications and changes will be apparent to those of ordinary skill in the art. The terms used herein are chosen to best explain the principles of the implementations, the actual application or the improvement of the technology in the market, or to enable other ordinary skilled persons in the art to understand the implementations disclosed herein.

1. A content retrieval method based on a machine learning model, comprising:
determining, in response to receiving a query request, a first content object associated with the query request, wherein the first content object comprises a plurality of content segments and a plurality of groups of identifications respectively corresponding to the plurality of content segments, and each group of identifications comprises at least a first index of a corresponding content segment;
providing the query request and the first content object to the machine learning model, to obtain at least one second index output by the machine learning model, wherein the at least one second index respectively indicates at least one target content segment in the plurality of content segments; and
extracting, based on the at least one second index and the plurality of groups of identifications, the at least one target content segment from the first content object, to answer the query request.

2. The content retrieval method according to claim 1, wherein determining the first content object comprises:
identifying the plurality of content segments from an original content object associated with the query request; and
adding the plurality of groups of identifications to the original content object based on a result of the identifying, to obtain the first content object.

3. The content retrieval method according to claim 2, wherein the plurality of content segments comprise multi-level content segments, and adding the plurality of groups of identifications to the original content object comprises:
determining a level of a first content segment in the plurality of content segments; and
adding, in the original content object, a level identification corresponding to the level of the first content segment as at least a part of the first index of the first content segment.

4. The content retrieval method according to claim 2, wherein adding the plurality of groups of identifications to the original content object comprises:
determining an order of a second content segment in the plurality of content segments in a group of content segments at a same level; and
adding, in the original content object, an order identification corresponding to the order of the second content segment as at least a part of the first index of the second content segment.

5. The content retrieval method according to claim 2, wherein adding the plurality of groups of identifications to the original content object comprises:
determining a start position of a third content segment in the plurality of content segments; and
adding, in the original content object, a corresponding start identification to the start position of the third content segment as at least a part of the first index of the third content segment.

6. The content retrieval method according to claim 2, wherein each group of identifications further comprises a termination identification, and adding the plurality of groups of identifications to the original content object comprises:
adding, in the original content object, the termination identification to respective identified end positions of the plurality of content segments respectively.

7. The content retrieval method according to claim 6, wherein the plurality of content segments comprise multi-level content segments, and adding the termination identification to the respective identified end positions of the plurality of content segments respectively comprises at least one of:
in response to determining that two adjacent content segments in the original content object are both at a first level, adding a first termination identification corresponding to the first level to an identified end position of a previous content segment in the two adjacent content segments; or
in response to determining that a previous content segment in two adjacent content segments in the original content object is at a second level and a subsequent content segment is at a third level higher than the second level, adding a plurality of termination identifications to an identified end position of the previous content segment, wherein the plurality of termination identifications comprise at least a second termination identification corresponding to the second level and a third termination identification corresponding to the third level.

8. The content retrieval method according to claim 1, wherein providing the query request and the first content object to the machine learning model comprises:
generating, based on the query request, the first content object, and a description of the plurality of groups of identifications, prompt information for the machine learning model; and
providing the prompt information to the machine learning model, to obtain, from the machine learning model, a model output indicating the at least one second index.

9. The content retrieval method according to claim 1, wherein extracting the at least one target content segment from the first content object comprises:
determining at least one group of identifications matching the at least one second index in the plurality of groups of identifications; and
extracting, based on the at least one group of identifications, the at least one target content segment from the first content object.

10. The content retrieval method according to claim 9, wherein each group of identifications comprises the first index of the corresponding content segment and a termination identification corresponding to the first index, the termination identification indicates an end position of the corresponding content segment, and extracting, based on the at least one group of identifications, the at least one target content segment from the first content object comprises:
extracting, based on at least one first index matching the at least one second index and at least one termination identification corresponding to the at least one first index, the at least one target content segment from the first content object.

11. An electronic device, comprising:
at least one processor; and
at least one memory coupled to the at least one processor and storing instructions executable by the at least one processor, wherein the instructions, when executed by the at least one processor, cause the electronic device to perform a content retrieval method based on a machine learning model, and the content retrieval method comprises:
determining, in response to receiving a query request, a first content object associated with the query request, wherein the first content object comprises a plurality of content segments and a plurality of groups of identifications respectively corresponding to the plurality of content segments, and each group of identifications comprises at least a first index of a corresponding content segment;
providing the query request and the first content object to the machine learning model, to obtain at least one second index output by the machine learning model, wherein the at least one second index respectively indicates at least one target content segment in the plurality of content segments; and
extracting, based on the at least one second index and the plurality of groups of identifications, the at least one target content segment from the first content object, to answer the query request.

12. The electronic device according to claim 11, wherein determining the first content object comprises:
identifying the plurality of content segments from an original content object associated with the query request; and
adding the plurality of groups of identifications to the original content object based on a result of the identifying, to obtain the first content object.

13. The electronic device according to claim 12, wherein the plurality of content segments comprise multi-level content segments, and adding the plurality of groups of identifications to the original content object comprises:
determining a level of a first content segment in the plurality of content segments; and
adding, in the original content object, a level identification corresponding to the level of the first content segment as at least a part of the first index of the first content segment.

14. The electronic device according to claim 12, wherein adding the plurality of groups of identifications to the original content object comprises:
determining an order of a second content segment in the plurality of content segments in a group of content segments at a same level; and
adding, in the original content object, an order identification corresponding to the order of the second content segment as at least a part of the first index of the second content segment.

15. The electronic device according to claim 12, wherein adding the plurality of groups of identifications to the original content object comprises:
determining a start position of a third content segment in the plurality of content segments; and
adding, in the original content object, a corresponding start identification to the start position of the third content segment as at least a part of the first index of the third content segment.

16. The electronic device according to claim 12, wherein each group of identifications further comprises a termination identification, and adding the plurality of groups of identifications to the original content object comprises:
adding, in the original content object, the termination identification to respective identified end positions of the plurality of content segments respectively.

17. The electronic device according to claim 16, wherein the plurality of content segments comprise multi-level content segments, and adding the termination identification to the respective identified end positions of the plurality of content segments respectively comprises at least one of:
in response to determining that two adjacent content segments in the original content object are both at a first level, adding a first termination identification corresponding to the first level to an identified end position of a previous content segment in the two adjacent content segments; or
in response to determining that a previous content segment in two adjacent content segments in the original content object is at a second level and a subsequent content segment is at a third level higher than the second level, adding a plurality of termination identifications to an identified end position of the previous content segment, wherein the plurality of termination identifications comprise at least a second termination identification corresponding to the second level and a third termination identification corresponding to the third level.

18. The electronic device according to claim 11, wherein providing the query request and the first content object to the machine learning model comprises:
generating, based on the query request, the first content object, and a description of the plurality of groups of identifications, prompt information for the machine learning model; and
providing the prompt information to the machine learning model, to obtain, from the machine learning model, a model output indicating the at least one second index.

19. The electronic device according to claim 11, wherein extracting the at least one target content segment from the first content object comprises:
determining at least one group of identifications matching the at least one second index in the plurality of groups of identifications; and
extracting, based on the at least one group of identifications, the at least one target content segment from the first content object.

20. A non-transitory computer-readable storage medium having computer-executable instructions stored thereon, wherein the computer-executable instructions are executable by a processor to implement a content retrieval method based on a machine learning model, and the content retrieval method comprises:
determining, in response to receiving a query request, a first content object associated with the query request, wherein the first content object comprises a plurality of content segments and a plurality of groups of identifications respectively corresponding to the plurality of content segments, and each group of identifications comprises at least a first index of a corresponding content segment;
providing the query request and the first content object to the machine learning model, to obtain at least one second index output by the machine learning model, wherein the at least one second index respectively indicates at least one target content segment in the plurality of content segments; and
extracting, based on the at least one second index and the plurality of groups of identifications, the at least one target content segment from the first content object, to answer the query request.
